(19) United States
(12) Patent Application Publication
(10) Pub. No.: US 2012/0096230 A1
(43) Pub. Date: Apr. 19, 2012

(54) METHOD AND SYSTEM FOR CREATING SNAPCLONE LOGICAL DISKS

(76) Inventor: Kishore Sampathkumar, Bangalore (IN)

(21) Appl. No.: 12/904,768

(22) Filed: Oct. 14, 2010

(51) Int. Cl. G06F 12/16; G06F 12/00

(52) U.S. Cl. 711/162; 711/E12.001; 711/E12.103

(57) ABSTRACT

Embodiments of the present invention are directed to a logical disk provided by a storage system. The logical disk comprises a number of data segments mapped to physical data-storage, metadata, stored in an electronic memory and/or mass-storage devices, that includes, for each segment of the logical disk, a three-bit field, and a set of operations, carried out by a storage-system controller, that can be directed to the logical disk by an entity that accesses the storage system, including a snapclone operation that generates a snapclone of the logical disk and a snapshot operation that generates a snapshot of the logical disk, an existing snapshot of the logical disk, or a snapclone of the logical disk.

### TECHNICAL FIELD

The present invention is related to data-storage systems and, in particular, to a data-storage system, and method incorporated within the data-storage system, for generating efficient and flexible snapclone logical disks.

### BACKGROUND

Electronic data-storage components and systems are integral components and subsystems of modern computing systems, including large distributed computing systems containing multiple networked computers and multiple networked data-storage subsystems. In early computers, data was principally stored in various types of electronic memory within individual computers. Mass-storage devices were subsequently developed, including magnetic tape and disk storage devices, to provide for greater storage capacities, non-volatile data storage, and transportable stored data. Mass-storage devices have evolved as quickly as, and, in certain cases, even more rapidly than computer processors and computer systems. The densities at which data can be stored on disk-platter surfaces and optical-disk surfaces has increased even more quickly than the densities at which integrated-circuit components, such as transistors, can be manufactured on the surfaces of silicon dies.

Not only have the densities at which data can be stored increased rapidly, over the past decades, but the functionalities of mass-storage devices have also rapidly evolved. Network data-storage devices and systems, such as disk arrays, currently provide enormous data-storage capacities as well as flexible and powerful interfaces for storing and managing data by remote host computers. In many cases, these high-end data-storage devices provide logical-disk-based interfaces that allow host computers to create various types of logical disks that are mapped, by data-storage-device controllers, through various levels of interfaces to disk drives and data-block addresses within disk drives. Logical disks may be automatically mirrored or redundantly stored according to various types of redundancy schemes, including erasure-coding or parity-encoding redundancy schemes. Moreover, the logical disks may be automatically geographically dispersed, automatically archived, and associated with various other features and facilities provided by the disk array. Disk arrays and other high-end data-storage devices that provide logical-disk interfaces to host computers may provide a variety of different types of operations that can be carried out on, or directed to, logical disks, including snapshot and snapclone operations. Snapshot operations generate snapshot logical disks associated with a base logical disk. A snapshot can be considered to be an instantaneous copy of a logical disk, although, in many implementations, data is copied to the snapshot on an as-needed basis. Multiple snapshots can be generated for a given logical disk to form time-ordered chains or linked lists of snapshots. Snapclones are similar to snapshots, except that snapclones are intended to become independent logical disks once data from the base logical disk is coped to the snapclone. While the operations on logical disks provided by a data-storage-device interface to host computers have proved extremely useful for data storage and management, designers, manufacturers, and users of data-storage systems continue to seek additional operations and functionality with respect to operations carried out on logical disks to further enhance data-storage-system functionality and utility.

### BRIEF DESCRIPTION OF THE DRAWINGS

FIG. 1 shows, at high level, an example disk array.

FIG. 2 illustrates three different mappings within an example disk array.

FIG. 3 illustrates address translations carried out at each of the mappings shown in FIG. 2.

FIG. 4 illustrates a general-purpose computer architecture on which data-storage systems, including high-end disk arrays, may be based.

FIG. 5 illustrates a logical disk according to one embodiment of the present invention.

FIGS. 6A-B illustrate snapshot logical disks generated by a snapshot operation carried out on a base logical disk.

FIG. 7 illustrates a snapclone.

FIG. 8 illustrates a series of snapshot and snapclone operations that together generate a linked-list-like stack of snapshots and snapclones.

FIGS. 9A-N illustrate various operations carried out on a linked-list-like stack of snapshots and snapshot clones associated with a base logical disk.

FIGS. 10A-B illustrate the snapclone operation that represents one embodiment of the present invention.

FIGS. 11A-C provide control-flow diagrams that describe aspects of the snapclone operation and snapclone logical disks that represent embodiments of the present invention.

FIGS. 12A-12E illustrate various operations conducted on a snapclone that represents one embodiment of the present invention.

### DETAILED DESCRIPTION

Embodiments of the present invention are directed to snapclone operations on logical disks included as components of a logical-disk interface provided by any of various types of data-storage systems to host computers and other remote accessing entities. These snapclone operations provide greater flexibility and efficiency than currently available snapclone operations. The snapclone operations to which embodiments of the present invention are directed are implemented in software and hardware within data-storage systems, and are thus functional components of the data-storage systems.

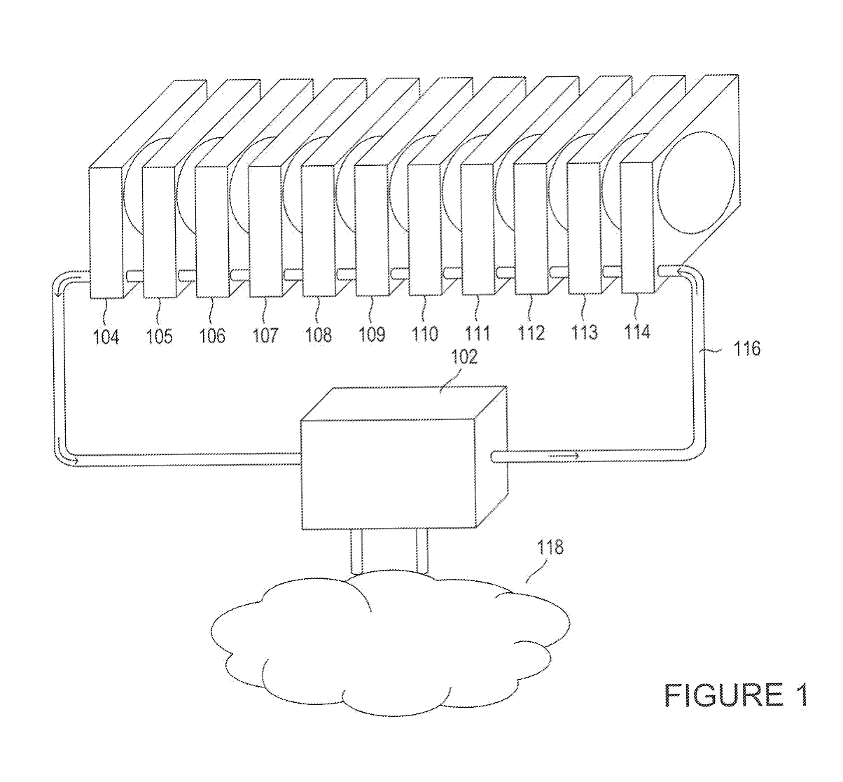

FIG. 1 shows, at high level, an example disk array. The disk array includes a disk-array controller 102 and multiple mass-storage devices, commonly multi-platter disk drives 104-114, generally linked together by one or more high-bandwidth communications media 116 internal to the disk array. The data stored within the disk array is accessed, by host computers, through an external communications medium 118. FIG. 1 is not intended to illustrate the actual appearance of a disk array, or describe the many additional components within a disk array, including redundant power supplies, various peripheral devices, consoles, and other such components. Instead, for the purposes of describing the present invention, it is sufficient to understand that the basic disk-array architecture comprises a disk-array controller or multiple disk-array controllers interconnected with multiple mass-storage devices.

In general, the disk-array controller includes one or more processors and controller firmware and software that together implement a logical-unit-based interface through which remote host computers access data stored on the mass-storage devices. The disk-array controller 102 translates logical unit numbers (“LUNs”) and block addresses associated with LUNs to logical block addresses within individual mass-storage devices. In addition, the disk-array controller includes sophisticated logic for automatic, redundant storage of data, for remapping stored data in the event of hardware problems or faults, and for many other functionalities directed to providing highly-available, fault-tolerant, and flexible data storage on behalf of remote host computers.

In the following discussion, disk arrays are referred to as “arrays.” While arrays commonly include many high-capacity and high-speed disk devices, arrays may employ additional types of mass-storage devices and/or combinations of different types of mass-storage devices. The present invention is not concerned with details of data storage at the mass-storage-device level, and is applicable to arrays employing any number of different types of mass-storage devices.

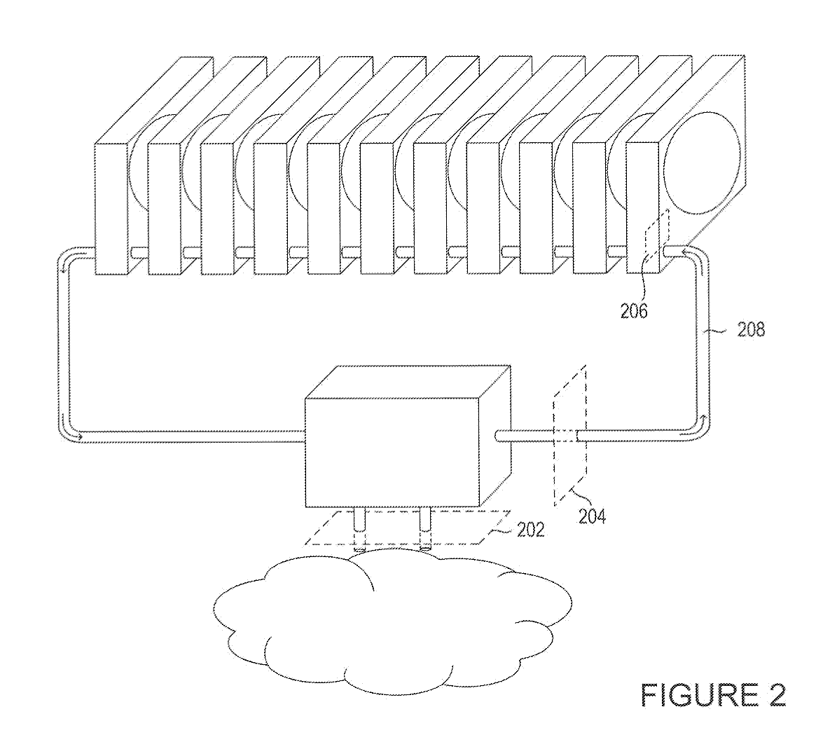

FIG. 2 illustrates three different mappings within an example disk array. A first mapping 202 associates a particular array, or array controller, with one or more network addresses. A second mapping 204 maps LUNs and block addresses associated with LUNs to particular mass-storage devices and associated logical-block addresses. A third mapping 206, within each mass-storage device, associates logical-block addresses with physical-block addresses. There may be, in many arrays and mass-storage devices, many additional levels of mappings.

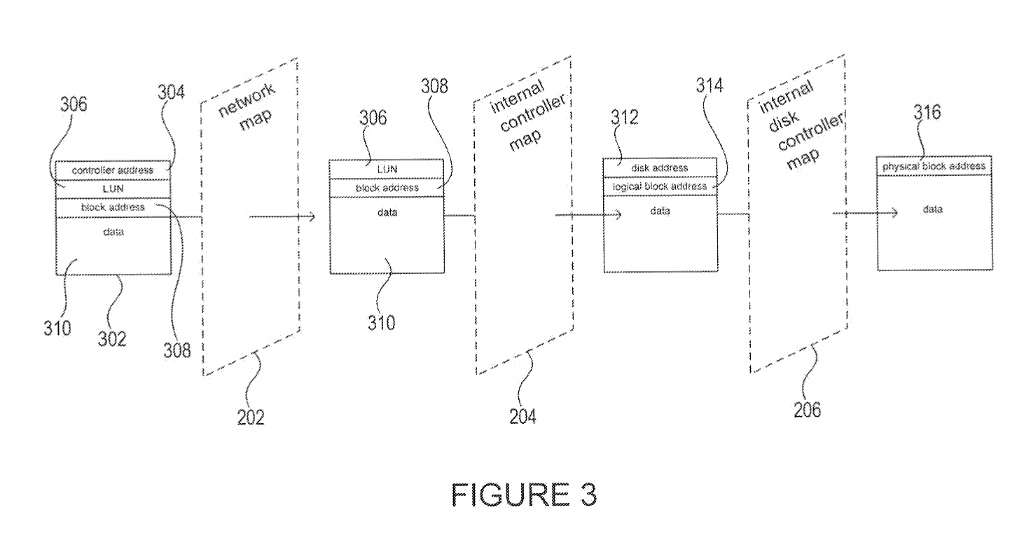

FIG. 3 illustrates address translations carried out at each of the mappings shown in FIG. 2. A host computer may direct data for a WRITE operation to an array via a communications message 302 that includes the network address of the array controller 304, a LUN 306, a data-block address 308, and the data to be written 310. The communications message 302 may comprise one or more packets exchanged over the communications medium according to one or more communications protocols. The first level of mapping 202, discussed above with reference to FIG. 2, directs the WRITE operation to a particular array based on the array-controller network address 304. The array controller translates the LUN and data-block address to a mass-storage-device address 312 and a logical-block address 314 associated with the mass-storage device, as represented in FIG. 2 by the second mapping 204. The mass-storage-device address 312 is generally a communications-medium address for the internal communications medium (208 in FIG. 2) within the array. When the WRITE operation is received by the mass-storage device, the mass-storage device translates the logical-block address 314, via a third mapping 206, to a physical-block address 316 by which the mass-storage-device controller locates the block within the mass-storage device in order to carry out the WRITE operation. In FIG. 3, and in the discussion below, data-access operations, including WRITE and READ, are assumed, for convenience, to be directed to individual data blocks stored within the array. However, data may be generally accessed at larger granularities, and, in certain systems, at smaller granularities.

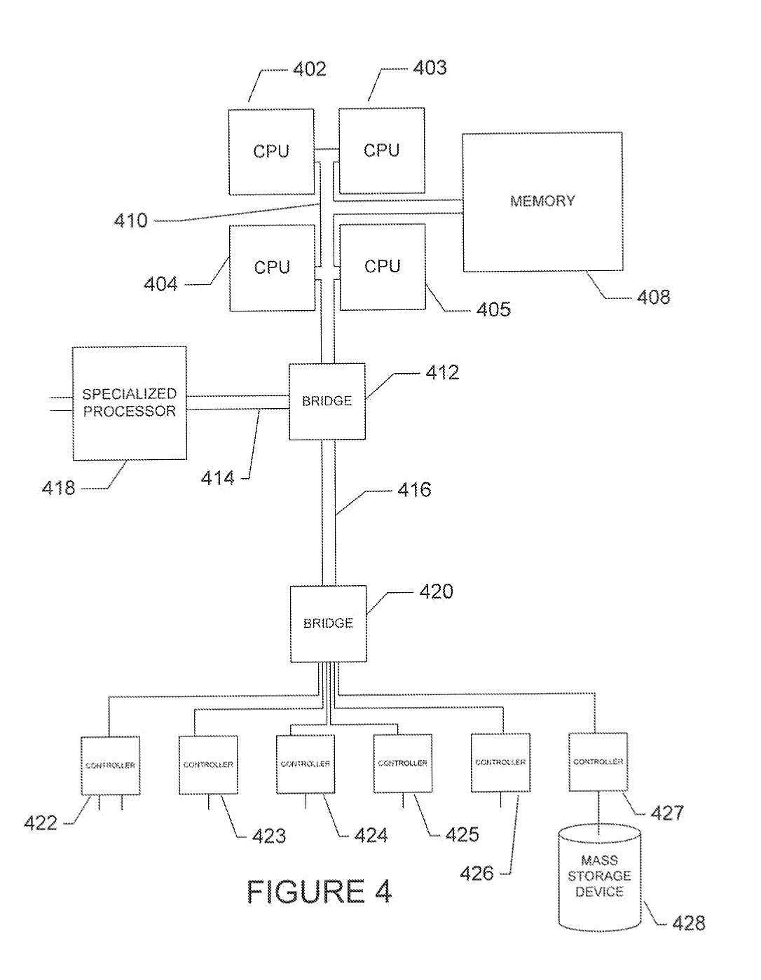

FIG. 4 illustrates a general-purpose computer architecture on which data-storage systems, including high-end disk arrays, may be based. For example, a data-storage system may implement data-storage-system controllers as a collection of controller routines that execute within any of various types of computer architectures. The computer system contains one or multiple central processing units (“CPUs”) 402-405, one or more electronic memories 408 interconnected with the CPUs by a CPU/memory-subsystem bus 410 or multiple busses, a first bridge 412 that interconnects the CPU/memory-subsystem bus 410 with additional busses 414 and 416, or other types of high-speed interconnection media, including multiple, high-speed serial interconnects. These busses or serial interconnections, in turn, connect the CPUs and memory with specialized processors, such as a graphics processor 418, and with one or more additional bridges 420, which are interconnected with high-speed serial links or with multiple controllers 422-427, such as controller 427, that provide access to various different types of mass-storage devices 428, electronic displays, input devices, and other such components, subcomponents, and computational resources. Embodiments of the present invention may also be implemented on distributed computer systems and can also be implemented partially in hardware logic circuitry.

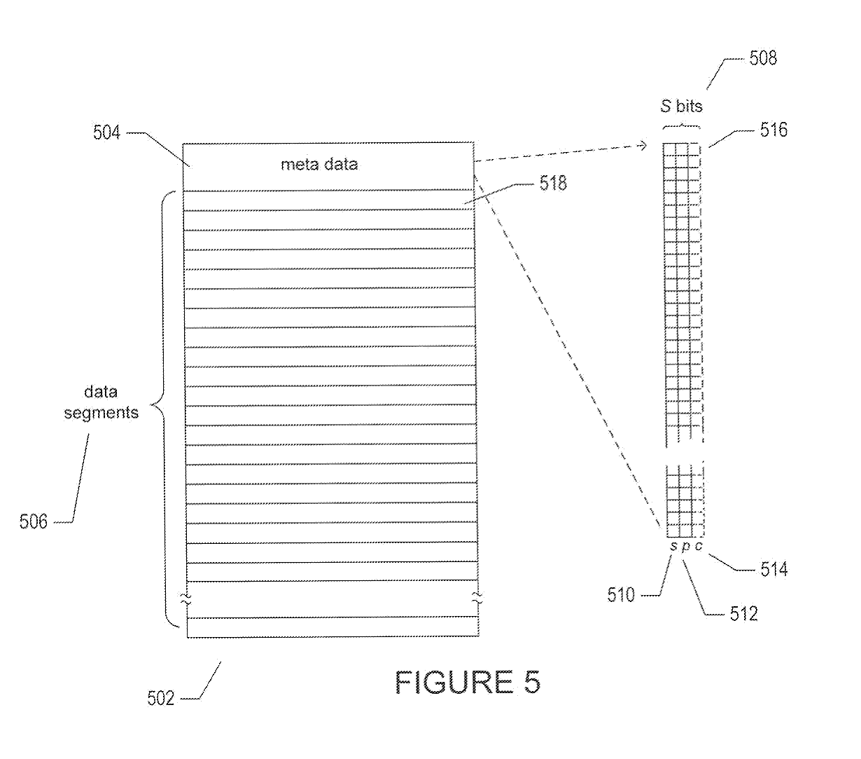

In the following discussion, it is assumed that a data-storage system provides a logical-disk interface to remote host computers, where logical disks are equivalent, similar to, or subsets of the logical units discussed above. A logical disk is basically an abstract data container that can be created and accessed for data storage and data retrieval by remote accessing entities, such as remote host computers. FIG. 5 illustrates a logical disk according to one embodiment of the present invention. As shown in FIG. 5, the logical disk 502 includes metadata 504, stored in one or more electronic memories and/or mass-storage devices, which describes the layout and various characteristics of the logical disk and a number, often large, of data segments 506. For purposes of describing embodiments of the present invention, the data segments are considered to be sequentially ordered and associated with monotonically increasing data-segment numbers. In practice, the structure of a logical disk, shown in FIG. 5, is mapped through various transformations and interfaces to physical locations on mass-storage devices within a data-storage system as well as in various types of electronic memory and memory caches.

A portion of the metadata 504 that describes a logical disk and its characteristics includes a set of bits, referred to as S bits, associated with data segments 508. The data segments of currently-available logical disks are each associated with two different bits, the s bit, alternatively referred to as the “successor bit,” 510, and the p bit, alternatively referred to as the “predecessor bit,” 512 in one type of logical-disk metadata. In certain embodiments of the present invention, a third c bit, alternatively referred to as the “clone bit,” 514 is associated with each data segment of a base logical disk. The S bits 508 form a type of map, comprising an array of bit fields logically aligned with data segments. For example, the first three bits in the first row 516 of the S-bits array 508 includes the s, p, and c bits associated with the first data segment 518 of the logical disk 502, according to one embodiment of the present invention. The function of the S bits is described, in great detail, following discussion of snapshot and snapclone operations.

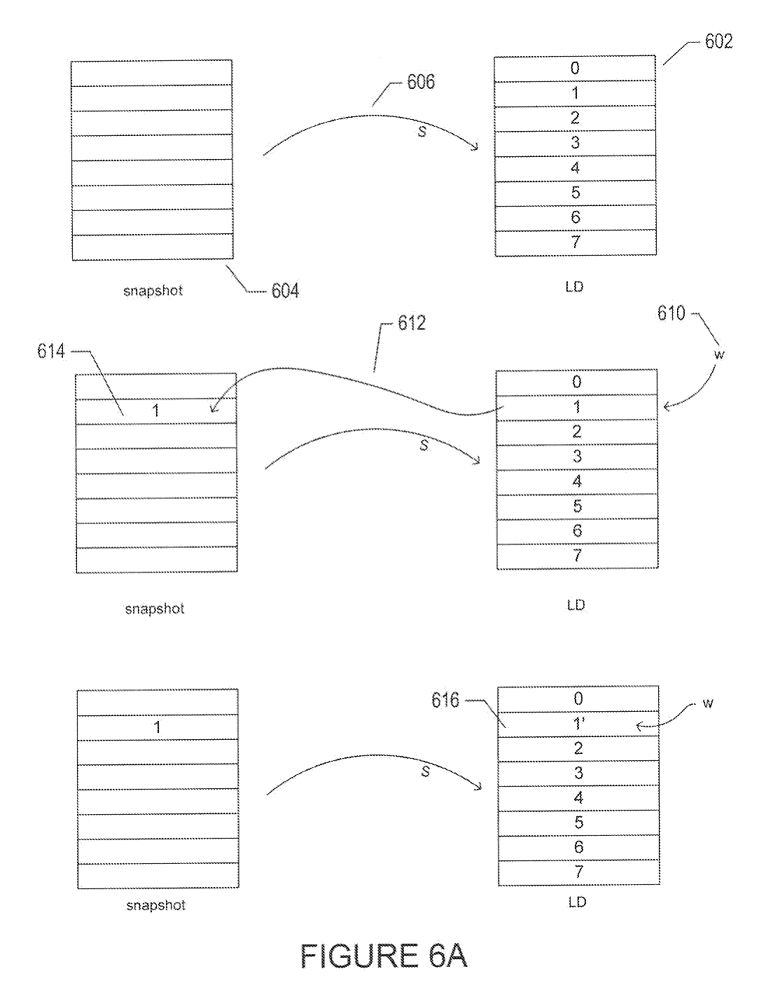

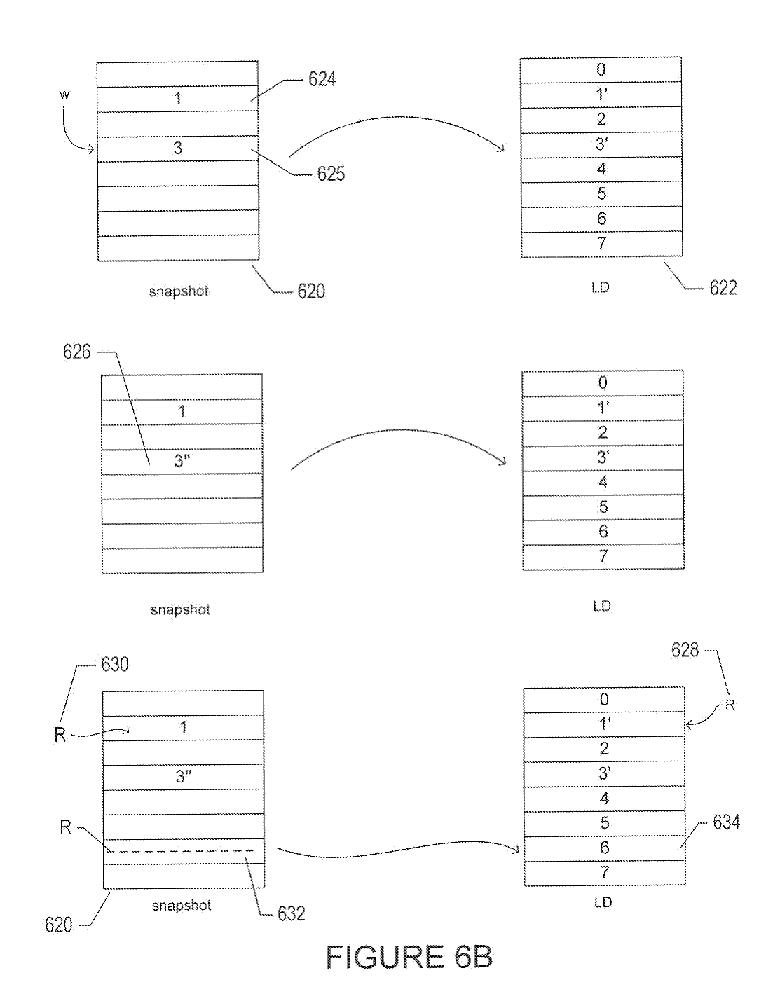

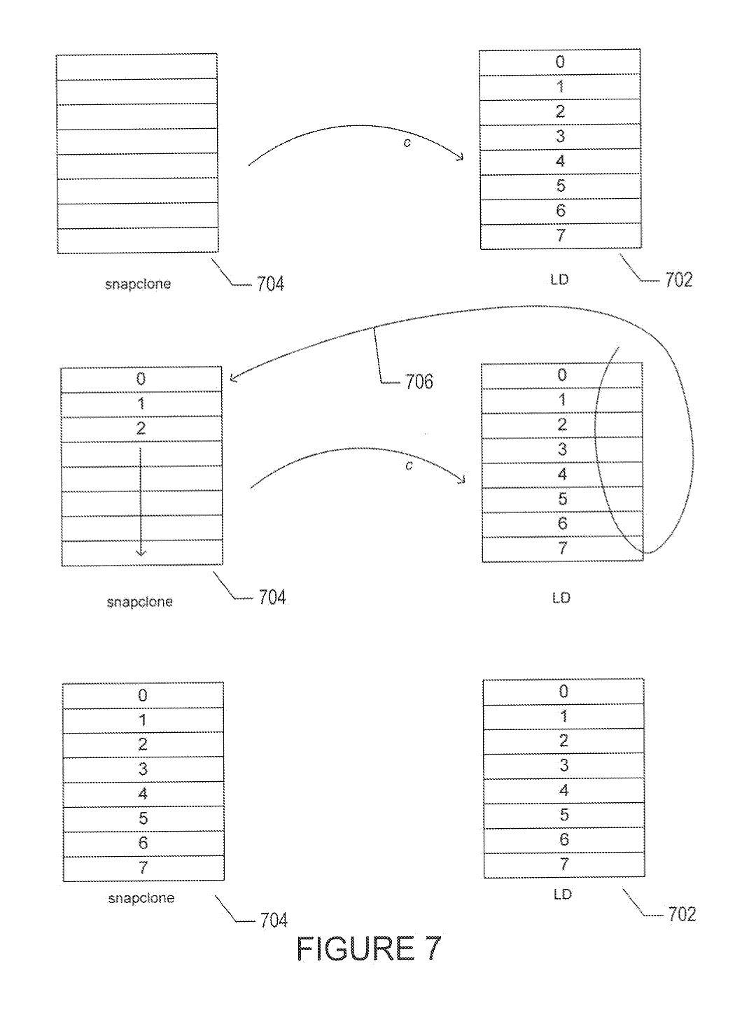

FIGS. 6A-B illustrate snapshot logical disks generated by a snapshot operation carried out on a base logical disk. FIGS. 6A-B and FIG. 7 all use the same illustration conventions. A logical disk is represented as a list of segments 602. Of course, in an actual implementation, a logical disk generally includes hundreds, thousands, millions, or more data segments. For illustration clarity, extremely small logical disks, snapshots, and snapclones are shown in FIG. 6A and subsequent figures. In general, the data segments of the logical disk 602 are generated by various storage-space-allocation operations and WRITE operations directed to a logical disk. Data segments, or portions of data segments, are retrieved by READ operations and written by WRITE operations. Data-storage devices generally provide many other types of operations that can be carried out with respect to logical disks.

One type of operation that can be performed on the logical disk, illustrated in FIGS. 6A-B, is a snapshot operation. A snapshot operation generates a snapshot logical disk 604 that is linked 606 to a base logical disk 602. The snapshot logical disk represents an instantaneous copy of the contents of the base logical disk at the point in time at which the snapshot operation is invoked. Initially, the snapshot may contain no data, but instead references to the data contained in the base logical disk. Often, a snapshot of a logical disk is taken as an archival point, in time, following which the logical disk may be updated. Often, the updates involve adding new data to the existing data within the logical disk. Much or all of the data that existed at the time of the snapshot may remain unchanged, following the snapshot, and thus copying the data to the snapshot would generate needless data redundancy. Therefore, in general, data is copied from the base logical disk to the snapshot when that data segments referenced from the snapshot to the base logical disk are subsequently overwritten or updated in preparation for WRITE operations directed to the snapshot. For example, consider a WRITE operation directed to the first data segment of the base logical disk after snapshot 604 is created. In order to carry out the WRITE operation 610, the contents of the first data segment are copied 612 to the first data segment of the snapshot logical disk 614 and then the WRITE operation is carried out on the first data segment 616 of the base logical disk. In FIG. 6A, and in subsequent figures, updated or overwritten data segments are indicated by appending apostrophes to the data segment numbers. For example, in FIG. 6A, overwriting of the first data segment “1” produces the overwritten or updated data segment “1′.” Thus, as shown in FIG. 6A, snapshot 604 was initially empty, but subsequently acquired the first data segment 614 in a copy-before-WRITE operation in preparation for carrying out a WRITE operation on the first data segment of the base logical device.

Snapshots can be used as an archival mechanism, where snapshots are taken at regular intervals in time to form a series of checkpoints or intermediate archival points for a logical disk that continues to be updated. Should, for example, data on the logical disk become corrupted, a snapshot taken prior to generation of the corrupted data can be accessed in order to restore the logical disk to an uncorrupted state. However, the snapshot mechanism is often implemented to be more general. Rather than remaining static intermediate archival points, snapshots themselves can be updated independently, without parallel updates to the base logical disk with which the snapshots are associated. For example, in FIG. 6B, snapshot 620 associated with base logical disk 622 contains two actual data segments 624-625, with the remaining data segments comprising references to corresponding data segments in the base logical disk 622. A WRITE operation can be carried out, as shown in FIG. 6B, on the third data segment 625 of the snapshot 620. The WRITE operation generates a new third data segment 3″ 626. Of courses, as a result of the WRITE operation directed to snapshot 620, the original value of the third data segment, 3 (625 in FIG. 6B), is lost. As shown in the lower portion of FIG. 6B, READ operations 628 and 630 directed to the logical disk or to actual data segments within a snapshot return the contents of the logical-disk data segment or actual data segment within a snapshot. However, a READ of a data segment containing a reference to the logical-disk segment within a snapshot, such as the seventh data segment 632 in snapshot 620, is directed through the reference to the corresponding data segment 634 of the base logical disk.

FIG. 7 illustrates a snapclone. A snapclone is similar to a snapshot, except that the snapclone is intended to become an independent logical disk, over time. In FIG. 7, a snapclone operation directed to a base logical disk 702 generates a snapclone logical disk 704. Initially, as with a snapshot logical disk, the snapclone logical disk 704 contains references to the data segments of the logical disk 702. However, unlike a snapshot logical disk, the snapclone logical disk is associated with a background copy operation invoked when the snapclone is created. As shown in the central portion of FIG. 7, the background copy operation 706 cycles through the data segments of the base logical disk that existed at the time that the snapclone was created and copies the data segments to the snapclone logical disk 704 over time. When the background-copy operation finishes, as shown in the lower portion of FIG. 7, the snapclone becomes an independent, fully populated logical disk representing the contents of the base logical disk at the time that the snapclone was created. Note that, in the lower portion of FIG. 7, the background copy operation has completed and the snapclone logical disk 704 is no longer shown as being linked to base logical disk 702.

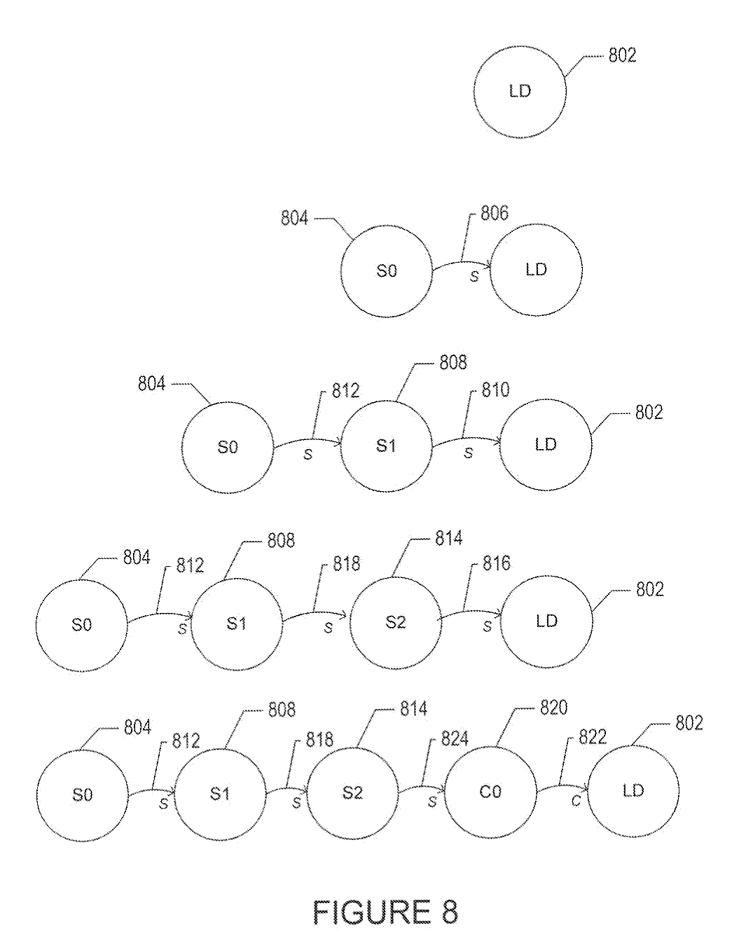

FIG. 8 illustrates a series of snapshot and snapclone operations that together generate a linked-list-like stack of snapshots and snapclones. Initially, as shown in FIG. 8, there may be a single base logical disk 802. A first snapshot operation carried out on the base logical disk generates a first snapshot logical disk 804 linked 806 to the base logical disk. A second snapshot operation carried out on the base logical disk produces a second snapshot logical disk 808 directly linked to the logical disk 810, to which the first snapshot logical disk 804 is linked 812. A third snapshot operation generates a third snapshot logical disk 814 linked directly 816 to the base logical disk 802 and additionally linked 818 to the second snapshot logical disk 808, in turn linked to the first snapshot logical disk 804. Finally, a snapclone operation carried out on the base logical disk 802 generates a snapclone logical disk 820 directly linked 822 to the base logical disk 802 and also linked 824 to the third snapshot logical disk 814. Thus, a series of snapshot operations bascially generates a stack of snapshot logical disks linked to the base logical disk, where the most recent snapshot logical disk occupies the top of the stack and is adjacent, or linked directly to, the base logical disk. A snapclone is placed at the top of the stack, as shown in the last diagram in FIG. 8. However, unlike snapshots, the snapclone remains at the top of the stack until the background-copy operation, discussed above, completes, at which point the snapclone is removed from the stack, regenerating the link-list-like stack of snapshot logical disks as the stack existed prior to the snapclone operation.

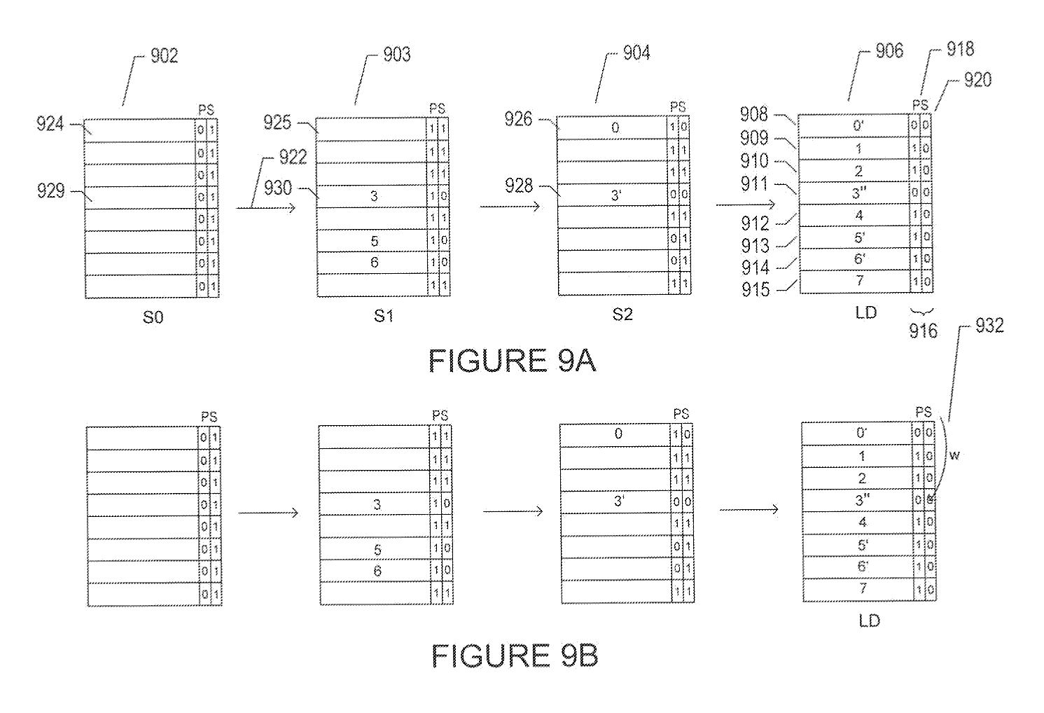

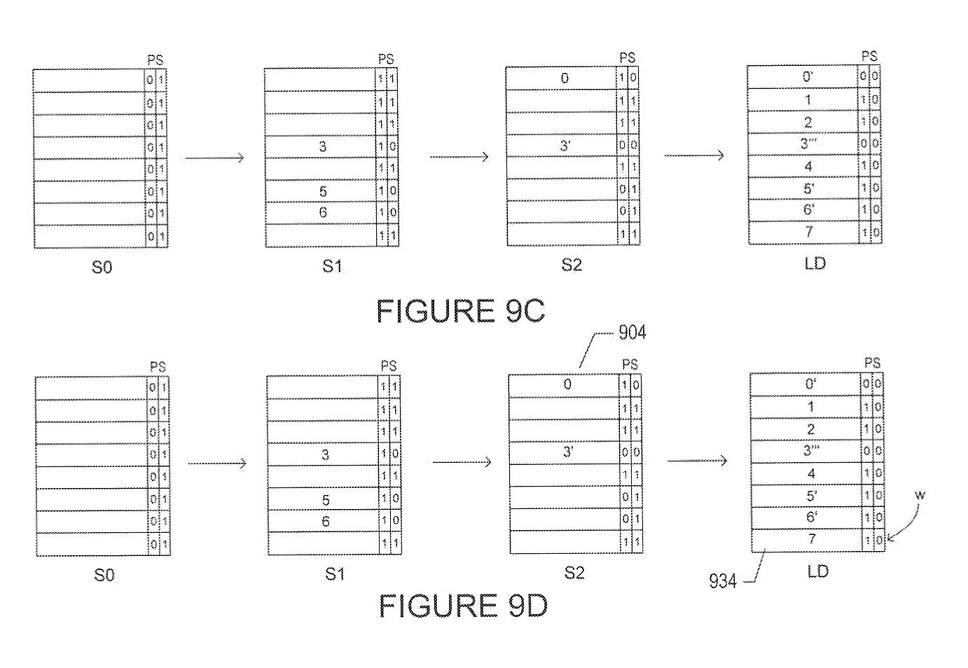

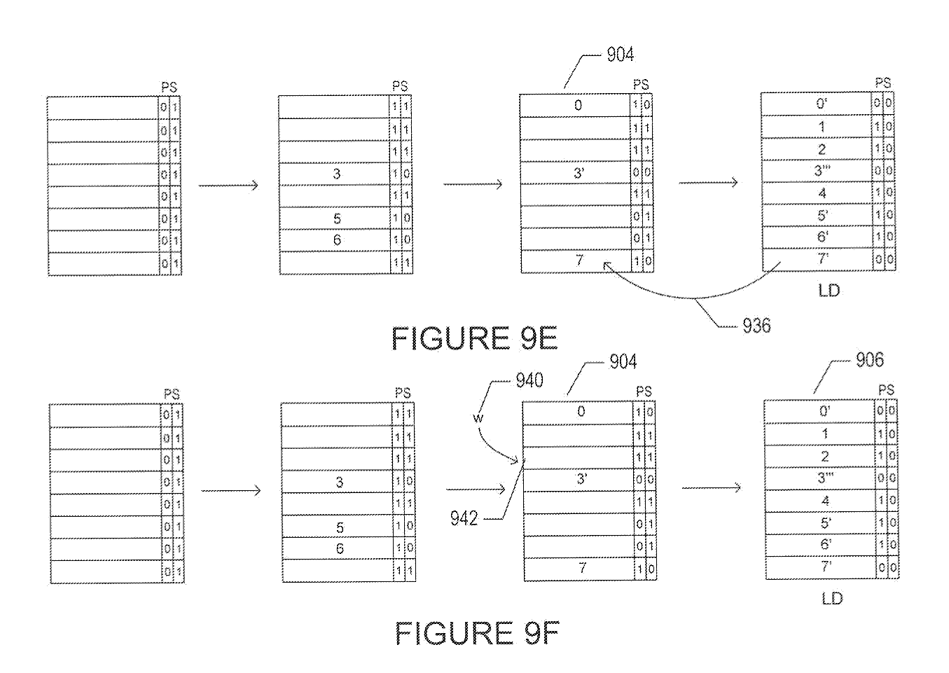

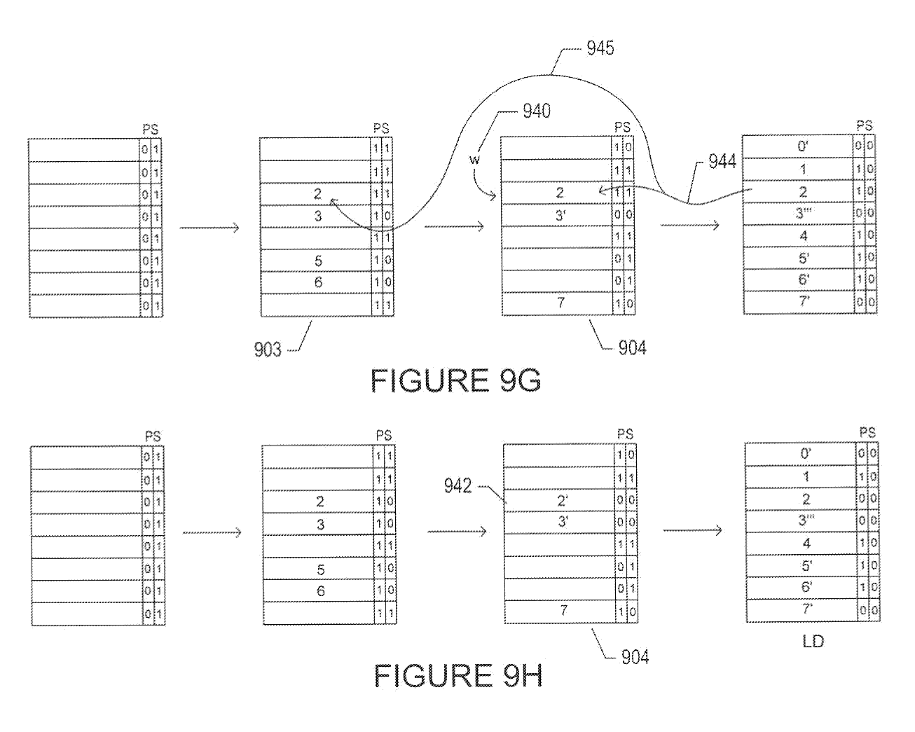

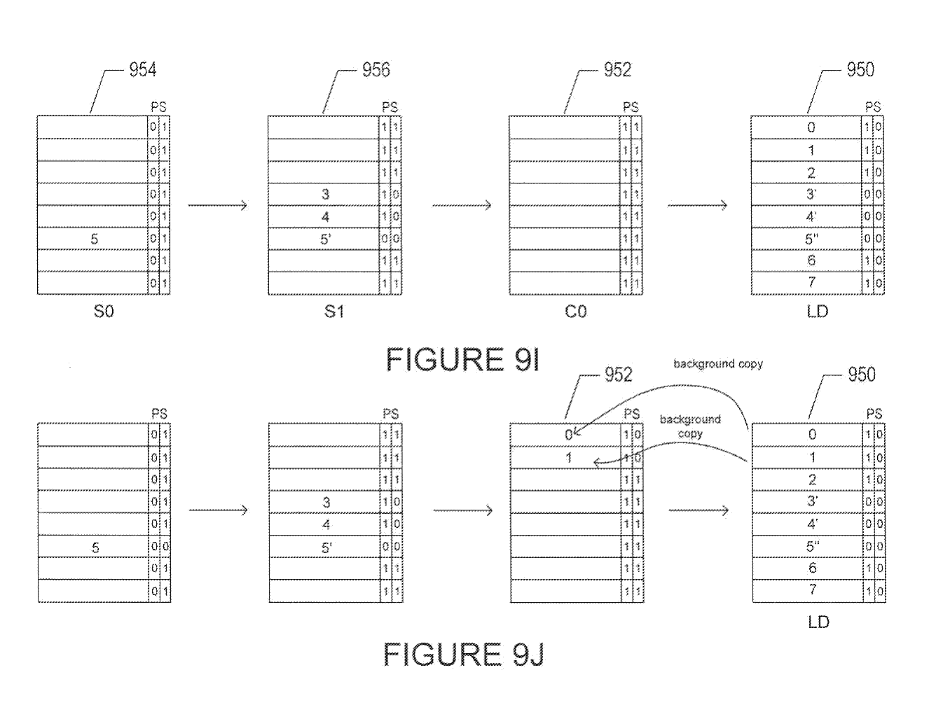

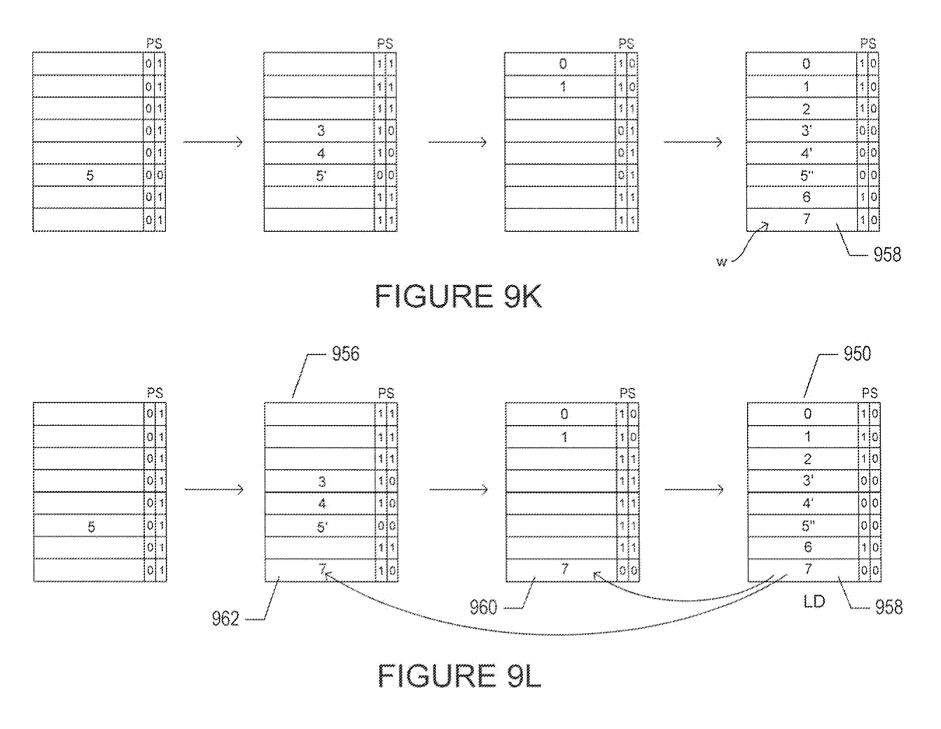

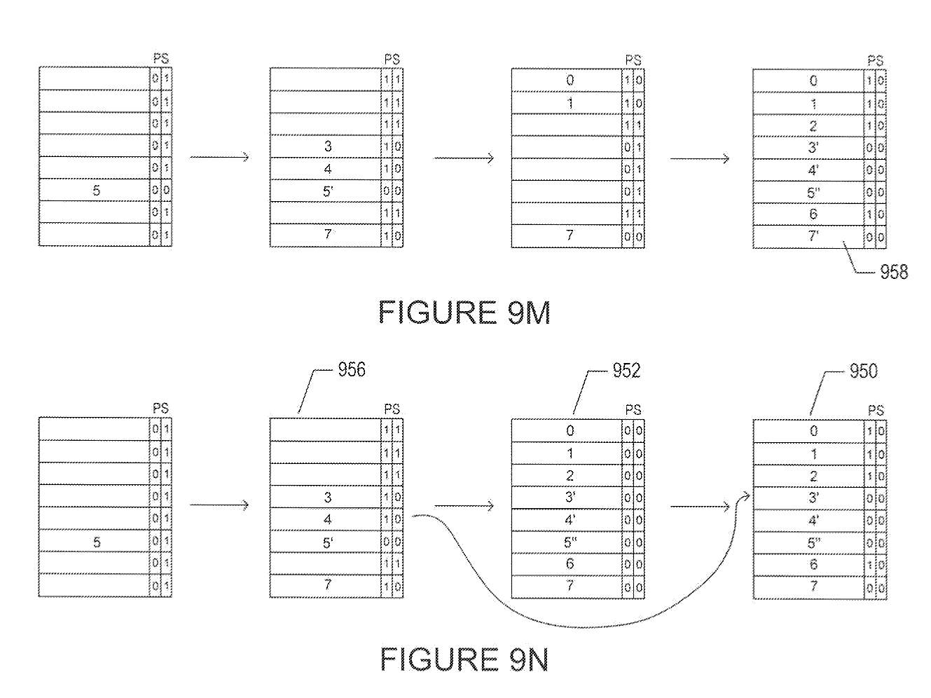

FIGS. 9A-N illustrate various operations carried out on a linked-list-like stack of snapshots and snapshot clones associated with a base logical disk. FIGS. 9A-N all use the same illustration conventions, next described with reference to FIG. 9A. Subsequent figures discussed below also use these same illustration conventions. FIG. 9A shows a linked-list-like stack of three snapshots 902-904 associated with a base logical disk 906. The snapshot logical disks 902-904 and the base logical disk 906 are all shown as small sequences of data segments, as in FIGS. 6A-B and 7, along with associated S bits p and s. Thus, for example, the logical disk 906 is represented as a sequence of eight data segments 908-915 and the S bits 916 associated with these segments, where the S bits include a column of p bits 918 and a column of s bits 920. As indicated in FIG. 9A, the snapshot logical disks 902-904 and the base logical disk 906 are linked together by logical links, such as logical link 922. These links may be stored in memory and/or incorporated in metadata associated with logical disks.

The p and s bits associated with the data segments can be thought of as pointers that interconnect individual data segments in the stack with one another. In other words, the snapshot logical disks and base logical disk are linked together in a snapshot stack by logical links, such as logical link 922, but the data segments within the snapshot logical disks and base logical disk are independently linked together via the p and s bits. For example, consider the first data segment 908 in the base logical disk 906. The s bit is basically a forward pointer. Because the s bit of the first data segment of the base logical disk has the value “0,” the first data segment of the base logical disk is located at the end of a linked list, and is not linked through the forward pointer represented by the s bit to a subsequent data segment. The value of the p bit associated with the first data segment of the base logical disk also has the value “0,” indicating that the first data segment of the base logical disk is not linked in a backward direction to any data segments. Thus, the first data segment of the base logical disk is a one-element linked list. The data segment is annotated with the symbols “0′,” while the corresponding data segment of the third snapshot logical disk 904 is annotated with the symbol “0.” This indicates that the first data segment of the base logical list was overwritten after the third snapshot logical disk 904 was created. When the first data segment of the base logical disk was overwritten, the link between the first data segment of the third snapshot logical disk and the first data segment of the base logical disk, comprising the s bit associated with the first data segment of the third snapshot logical disk and the p bit associated with the first data segment of the base logical disk, was broken by setting the s and p bits to the value “0.” Note, however, that the first and second snapshot logical disks 902 and 903 do not contain first data segments, but instead reference the first data segment of the third snapshot logical disk. Thus, the first data segments of the three snapshot logical disks 924-926 are linked together in a three-element linked list. A first element of the three-element link list is the first data segment 924 of the first snapshot logical disk 902. The p bit associated with that data segment has the value “0,” indicating that there are no additional data segments linked to the first data segment of the first snapshot logical disk in the backward direction. The s bit associated with the first data segment of the first snapshot logical disk 924 has the value “1,” indicating that the first data segment of the first snapshot logical disk is linked, in the forward direction, to the first data segment of the second snapshot logical disk 925. The p and s bits associated with the first data segment 925 of the second snapshot logical disk 903 both have values “1,” indicating that the first data segment 925 of the second snapshot logical disk 903 is linked to the first data segment of the previous snapshot logical disk 902 and the first data segment of the next snapshot logical disk 904. Finally, the first data segment of the third snapshot logical disk 904 is associated with a p bit with the value “1,” indicating a backward link to the first data segment 925 of the second snapshot logical disk 903 and an s value of “0,” indicating that the first data segment 926 of the third snapshot logical disk 904 is the final data segment in the three-element linked list. By similar reasoning, the fourth data segment of the base logical disk 911 is a single-element link list, as is the fourth data segment 928 of the third snapshot logical disk. The fourth data segments 929 and 930 of the first and second snapshot logical disks form a two-element linked list.

Thus, the p and s bits of the S bits associated with data segments are used to create one or more linked lists of corresponding data segments of the snapshot logical disks and base logical disk that may span the snapshot-logical-disk stack and associated base logical disk. The snapshot logical disks are time ordered with the most recent snapshot closest to the base logical disk. The linked list of snapshot logical disks is thus a push-down stack with the top of the stack adjacent to the base logical disk. A READ operation directed to a particular data segment of a particular snapshot logical disk passes along forward links through snapshot logical disks and, in certain cases, to the base logical disk until arriving at a data segment without a forward link. The contents of the data segment without a forward link represent the state of the data segment at the time that the snapshot logical disk to which the READ operation is directed was created.

FIGS. 9B-C illustrate a WRITE operation directed to the fourth data segment of the base logical disk associated with the snapshot stack shown in FIG. 9A. The WRITE operation is shown, in FIG. 9B, by the curved arrow 932 annotated with the symbol “W.” As discussed above, the fourth data segment of the base logical disk constitutes a one-element linked list, since the p and s bits associated with the fourth data segment both have value “0.” Because there are no references to the fourth data segment of the base logical disk from any snapshot logical disks associated with the base logical disk, the WRITE is executed to the fourth data segment of the base logical disk, as shown in FIG. 9C, without any additional data copies or S-bits changes.

By contrast, FIGS. 9D-E illustrate a WRITE directed to a data segment of the base logical disk of the logical-disk and snapshot stack shown in FIG. 9C that is referenced from the snapshot stack. As shown in FIG. 9D, a WRITE operation is directed to the eighth, or final, data segment 934 of the base logical disk. As shown in FIG. 9E, the WRITE is executed by first carrying out a copy of the original contents of the last element of the base logical disk 936 to the last element of the third snapshot logical disk 904, following the linked list that includes the last data segment of the base logical disk backward, with the existence of the link indicated by the value “1” in the p bit associated with the last data segment of the base logical disk, as shown in FIG. 9D, and then setting the s bit of the last data segment of the third snapshot to 0 and the p bit of the last data segment of the base logical disk to 0 in order to break the link between the last data segments of the base logical disk and the third snapshot logical disk. Only then is the WRITE operation carried out on the last data segment of the base logical disk, which now has the symbolic value “7′,” as shown in FIG. 9E. The copy-before-WRITE operation 936 thus preserves the original value of the last data segment of the base logical disk prior to overwriting the last data segment of the base logical disk.

FIGS. 9F-H illustrate a WRITE operation directed to the third snapshot logical disk of the snapshot-logical-disk stack and associated base logical disk illustrated in FIG. 9E. As shown in FIG. 9F, a WRITE operation 940 is directed to the third data segment 942 of the third snapshot logical disk 904. However, the third data segment of the third snapshot logical disk 904 is a reference to the corresponding data segment in the base logical disk 906. Therefore, as shown in FIG. 9G, prior to carrying out the WRITE operation, the contents of the third data segment of the base logical disk first needs to be copied both to the third data segment of the third snapshot logical disk 904 and to the third data segment of the second snapshot logical disk 903, as indicated by curved arrows 944-945. The copy-before-WRITE carried out to copy the contents of the third data segment into the third data segment of the third snapshot logical disk 904, to which the WRITE operation 940 is directed, is carried out in the case that the WRITE operation overwrites a portion of the data segment. The copy-before-WRITE operation 945 that transfers the original contents of the third data segment of the base logical disk to the corresponding data segment of the second snapshot logical disk 903 is needed because, once the WRITE operation is carried out, a second snapshot logical disk can no longer reference the former contents of the third data segment within the third snapshot logical disk. Finally, as shown in FIG. 9H, the WRITE operation is carried out, with the new symbolic contents of the third data segment of the third snapshot logical disk 904 now annotated with the symbols “2′.” Note also, in FIG. 9H, that the third data segment of the third snapshot logical disk 942 is now a one-element linked list, with the backward and forward links to the corresponding data segment of the second snapshot and the corresponding data segment of the base logical disk broken. This ensures that the correct value for the second data segment is returned by a READ operation directed to the third data segment of any of the snapshot logical disks or base logical disk.

FIGS. 9I-N illustrate a snapclone and operations carried out on a stack of snapshot logical disks and a snapclone logical disk associated with a base logical disk. As shown in FIG. 91, a snapclone operation directed to base logical disk 950 results in creation and initialization of a snapclone logical disk 952 placed at the top of the stack of snapshot logical disks and snapclone logical disk associated with the base logical disk 950. In the case shown in FIG. 91, the stack includes a first snapshot logical disk 954 and a second snapshot logical disk 956. Initially the snapclone logical disk 952 contains references to data segments in the base logical disk 950. However, as discussed above, a background-copy operation is immediately invoked, upon creation and initialization of the snapclone logical disk and, as shown in FIG. 9J, data segments are transferred from the base logical disk 950 to the snapclone logical disk 952. Note that, as each data segment is successfully copied from the base logical disk 950 to the snapclone logical disk 952, the links between the copied data segments of the base logical disk and snapclone logical disks are broken. In FIG. 9K, a WRITE operation is directed to the final data segment of the base logical disk 958 while the background-copy operation is underway. As shown in FIG. 9L, prior to carrying out the WRITE operation, the contents of the last data segment of the base logical disk 958 are first copied, by copy-before-WRITE operations, to the last data segment of the snapclone 960 as well as the last data segment of the second snapshot logical disk 962. The copy-before-WRITE operation directed to the last data segment of the snapclone is carried out because the original contents of the last data segment of the base logical disk is preserved in the snapclone since, by the time the background-copy operation proceeds to the last data segment of the base logical disk, the WRITE operation indicated in FIG. 9K will have changed the contents of the last data segment of the base logical disk, resulting in the changed contents, rather than the original contents, at the time the snapclone was created, being copied by the background-copy operation to the snapclone logical disk. To forestall that happening, the original contents of the last data segment are copied via a copy-before-WRITE operation and the links broken between the last data segment of the snapclone and the last data segment of the base logical disk, so that the last data segment of the base logical disk will not subsequently be copied to the snapclone and the background-copy operation eventually arrives at the last data segment. The copy-before-WRITE operation directed to the second snapshot logical disk 956 is carried out because, upon completion of the background-copy operation, the snapclone will be removed from the stack. Therefore, the snapshot logical disk preceding the snapclone in the stack cannot reference snapclone data segments. The snapshot logical disk preceding the snapclone in the stack can reference base-logical-disk data segments through the snapclone, but cannot reference data segments that are the final data segments on linked lists within the snapclone. Finally, as shown in FIG. 9M, the WRITE operation 958 to the last data segment of the base logical disk is carried out, with the contents of the last data segment now indicated to be “7′.” As shown in FIG. 9N, once the background-copy operation is complete, the snapclone logical disk 952 is completely removed from the stack, as a result of which the second snapshot logical disk 956 resumes a position at the top of the stack, adjacent to the base logical disk 950.

While the snapclone operation has proved to be a useful component of the logical-disk interface provided by data-storage systems to host computers and other accessing entities, the snapclone operation, as discussed above with reference to FIGS. 7 and 9I-N suffers certain deficiencies. First, as discussed above, the snapclone is positioned at the top of the stack of snapshot and snapclone logical disks. Thus, a single snapclone logical disk can be present at any given time, and it is not possible to create new snapshots of the base logical disk until the background-copy operation completes and the snapclone logical disk is removed from the stack. Furthermore, while the snapclone logical disk is positioned at the top of the stack of snapshot logical disks, and while the background-copy operation is underway, a snapshot of the snapclone logical disk cannot be taken. Furthermore, when a WRITE operation is directed to the snapclone, then a copy-before-WRITE operation is directed to the preceding snapshot logical disk, if such a snapshot logical disk exists, since the preceding snapshot logical disk cannot reference data segments within the snapclone, as discussed above. However, once the snapclone is removed from the stack, these copy-before-WRITE operations will have generated redundant data segments within the stack of snapshot logical disks if the corresponding data segments of the base logical disk have not been altered by WRITE operations. In other words, once the snapclone is removed from the stack, the snapshot logical disk at the top of stack will contain data segments copied from the base logical disk as a result of copy-before-WRITE operations carried out as part of executing WRITE operations directed to the snapclone and, in many cases, these data segments will be identical to corresponding data segments within the base logical disk. Once the snapclone logical disk is removed, the snapshot logical disk at the top of the stack could just as well reference data segments within the base logical disk, since these data segments have not changed. Thus, WRITE operations directed to the snapclone may result in unneeded copy-before-WRITE operations directed to the penultimate snapshot logical disk within the stack.

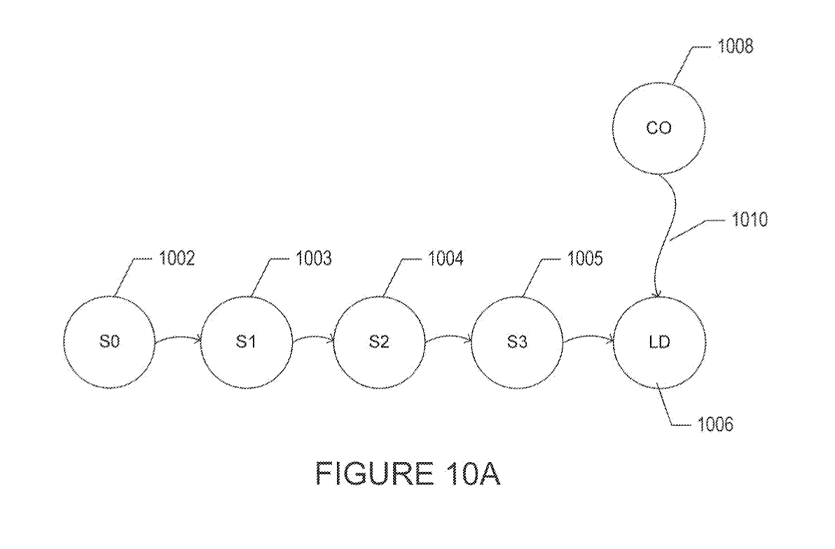

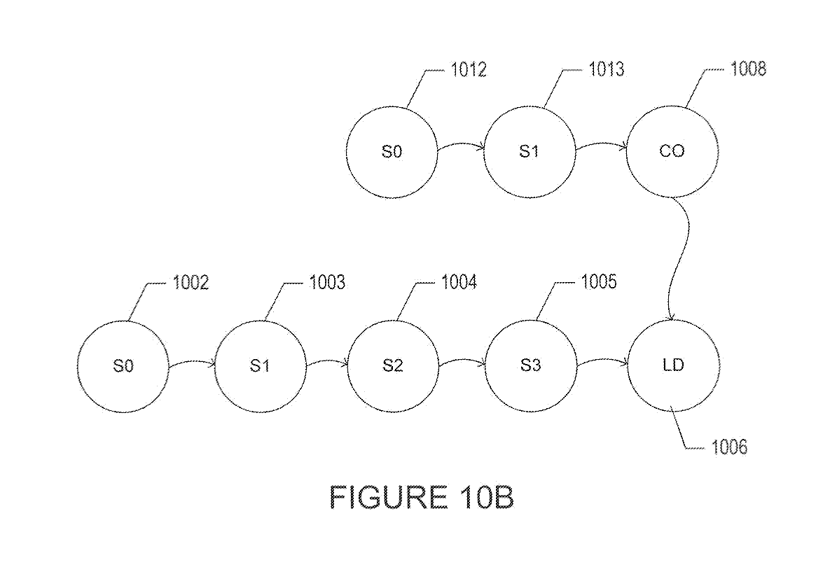

In order to address the above deficiencies and provide greatly increased flexibility and usability of snapclone operations, embodiments of the present invention are directed to a new, enhanced snapclone operation that links a snapclone to a base logical disk through a linked-list-like stack separate from the linked-list-like stack that includes snapshot logical disks associated with the base logical disk. FIGS. 10A-B illustrate the snapclone operation that represents one embodiment of the present invention. In FIG. 10A, a linked-list-like stack of snapshot logical disks 1002-1005 are shown linked to, or associated with, a base logical disk 1006. A snapclone operation directed to the base logical disk and associated snapshot logical disks 1002-1006 produces a snapclone logical disk 1008 that is linked 1010 to the base logical disk separately, and apart from, the linked-list-like stack of snapshot logical disks 1002-1005. As shown in FIG. 10B, following the snapelone operation, snapshots can be taken of the snapclone logical disk to produce a stack of snapshot logical disks 1012-1013 that are linked to the snapclone logical disk 1008 and that are entirely separate and distinct from the snapshot logical disks 1002-1005 that are associated with the base logical disk 1006. It is immediately apparent, from FIG. 10B, that two of the above-discussed deficiencies with currently available snapclone operations are addressed by the new snapclone operation that represents one embodiment of the present invention. There is no problem in executing snapshot operations against a snapclone logical disk created with the new snapclone operation, since the snapclone logical disk is located on a separate stack than the stack of snapshot logical disks associated with a base logical disk. Furthermore, there is no problem, with the new type of snapclone logical disk, in continuing to execute snapshot operations against the base logical disk, despite the presence of a snapclone logical disk associated with the base logical disk. The third deficiency associated with redundant copy-before-WRITE operations can also be seen to have been addressed by the new snapclone operation that represents one embodiment of the present invention. Because the snapclone 1008 does not reside within the stack of snapshot logical disks 1002-1005, it is unnecessary to carry out copy-before-WRITE operations on any of the snapshot logical disks prior to executing WRITE operations directed to the snapclone. The snapshot logical disks all reference one another and directly reference the base logical disk, and their contents are unaffected by WRITE operations directed to the snapclone.

The separate linking of a snapclone to a base logical disk discussed above with reference to FIGS. 10A-B is accomplished via the c bit of the S bits, discussed above with reference to FIG. 5, associated with the data segments of a base logical disk. The c bit is basically a second p bit applicable to a second stack linked to the base logical disk. Thus, a data segment of a base logical disk may have backward links to data segments in a first stack of snapshot logical disks via p bits and may also have backward links to data segments of a snapclone and associated snapshot logical disks of a second stack via c bits.

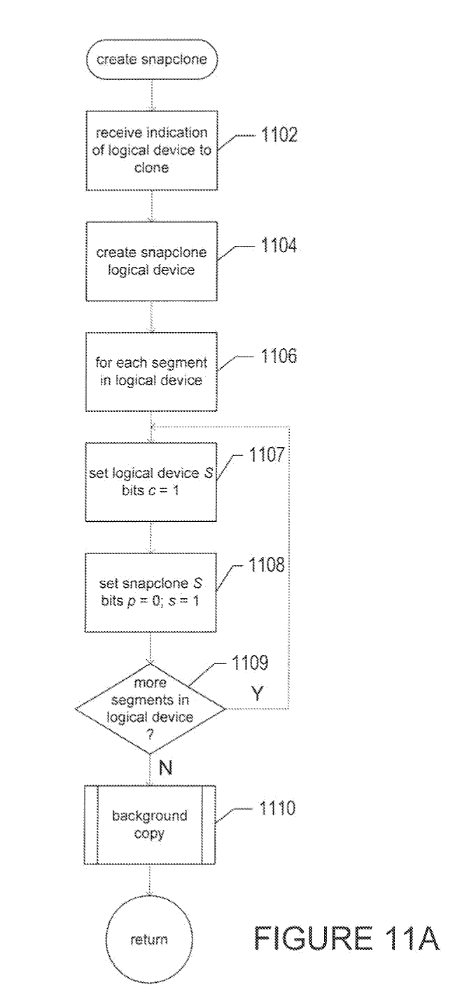

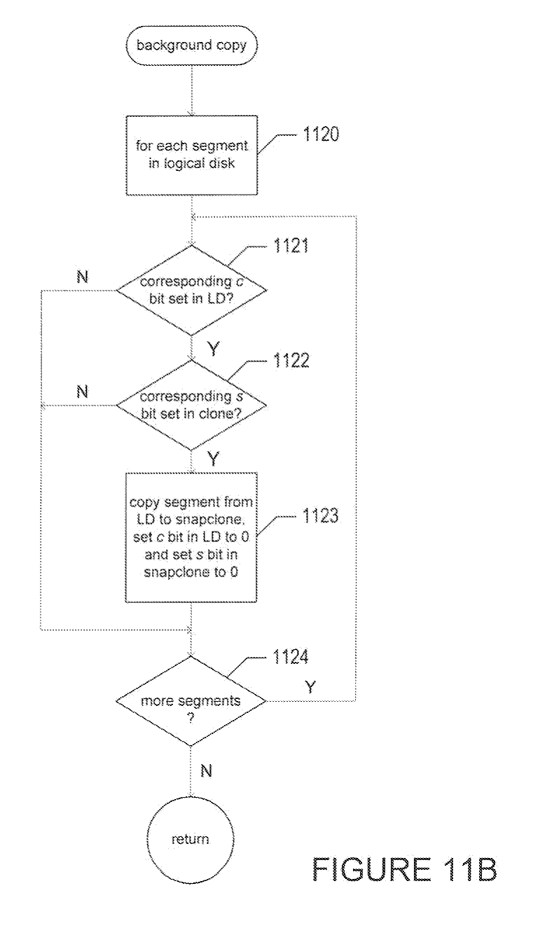

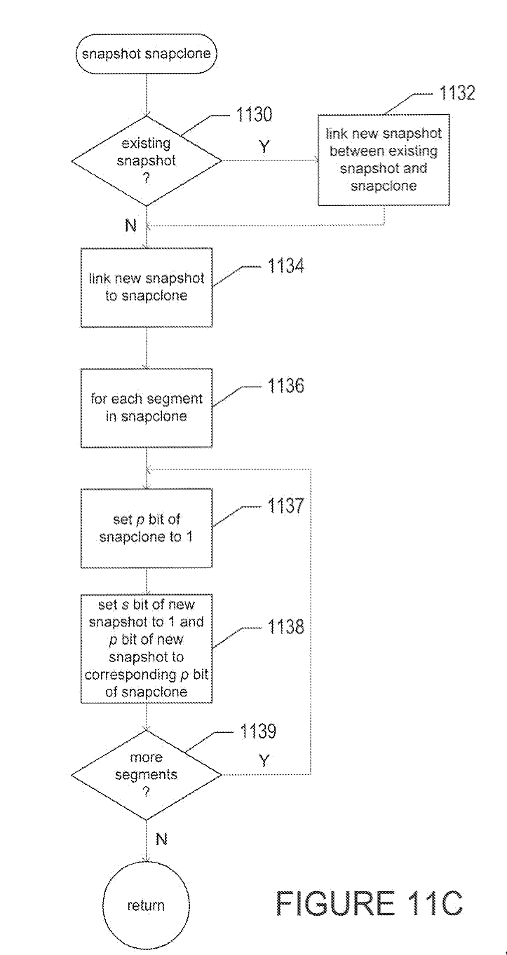

FIGS. 11A-C provide control-flow diagrams that describe aspects of the snapclone operation and snapclone logical disks that represent embodiments of the present invention. FIG. 11A provides a control-flow diagram of a snapclone-creation routine that implements the snapclone operation that represents one embodiment of the present invention. In block 1102, an indication of the logical device to which a snapclone operation is directed is received. In block 1104, a new snapclone logical device is created and linked to the target logical device, an indication of which is received in block 1102. In the for-loop of blocks 1106-1109, each data segment in the target logical device is considered in each iteration of the for-loop. For each data segment in the target logical device, the c bit is set to have value “1,” in block 1107, to link the data segment back to the new snapclone logical device. In block 1108, the p bit associated with the snapclone data segment is set to value “0,” and the s bit associated with the snapclone data segment is set to have value “1,” so that the snapclone data segment is forward linked to the corresponding data segment of the target logical device. Then, in block 1110, the background-copy operation discussed above is launched in order to copy the data segments of the target logical device to the snapclone logical device.

FIG. 11B provides a control-flow diagram for the background-copy routine invoked in block 1110 of FIG. 11A. The background-copy routine comprises a for-loop of blocks 1120-1124. For each data segment in the target base logical disk, in each iteration of the for-loop, the routine first checks to determine whether or not the c bit of the data segment is set in the base logical device, in block 1121. If so, then the routine checks to see if the corresponding s bit of the corresponding data segment in the snapclone is set, in block 1122. When both these bits are set, then the data segment is copied from the base logical device to the snapclone, in block 1123, following which the c bit associated with the data segment and the base logical device and the s bit associated with the data segment in the snapclone are both set to value “0.” This breaks the link between the snapclone, data segment and corresponding data segment of the base logical device.

FIG. 11C provides a control-flow diagram for a snapshot routine that creates a snapshot of a snapclone. If there already is a snapshot associated with a snapclone, as determined in block 1130, a new snapshot logical device is linked within the stack associated with the snapclone between the most recent, existing snapshot and the snapclone, in block 1132. Otherwise, a new snapshot is linked to the snapclone in block 1134. In the for-loop of blocks 1136-1139, for each data segment in the snapclone, the corresponding p bit within the snapclone is set to “1”, in block 1137, and the s bit and p bits associated with the corresponding data segment in the new snapshot are set to “1” and to the p-bit value of the corresponding snapclone data segment, respectively. Thus, the data segments of the new snapshot are all linked to corresponding data segments of the snapclone and linked to corresponding data segments of the preceding snapshot logical device, if one exists.

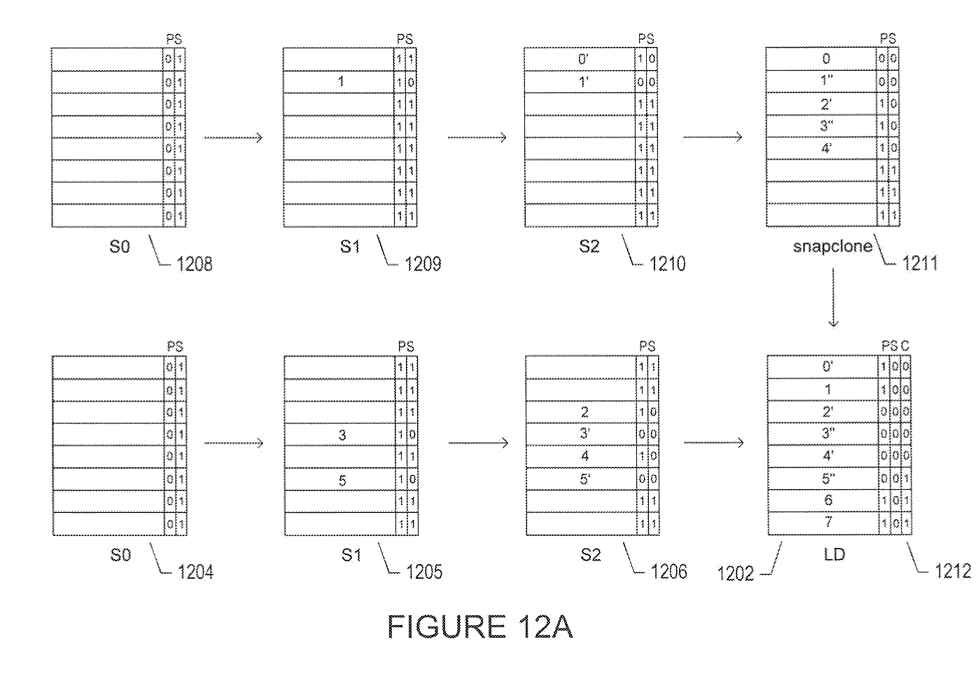

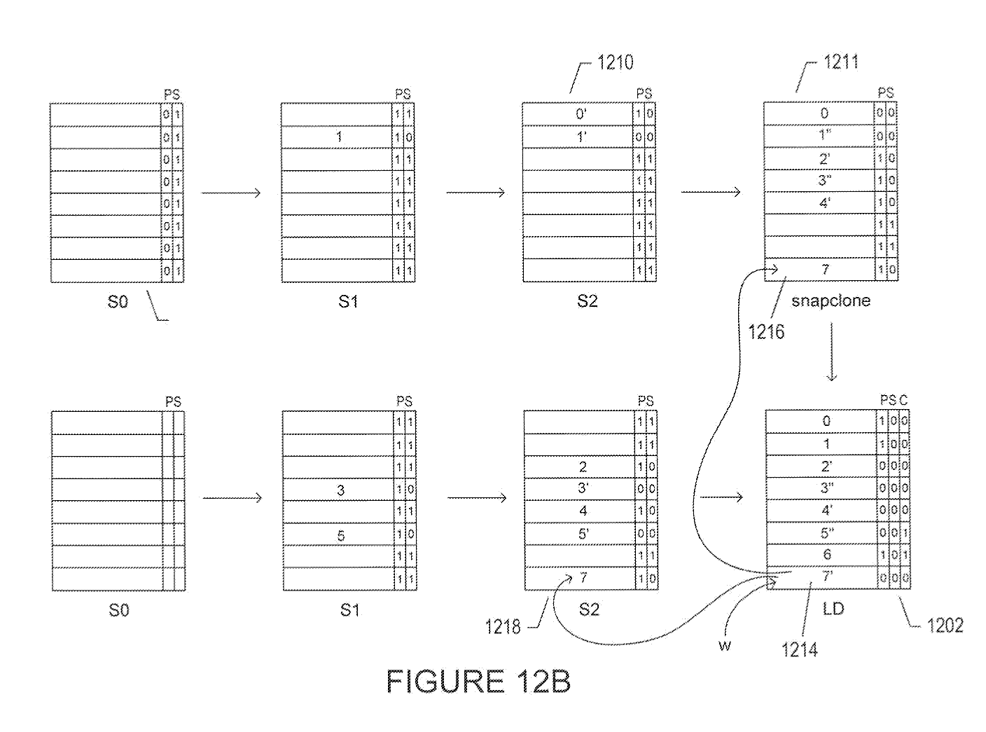

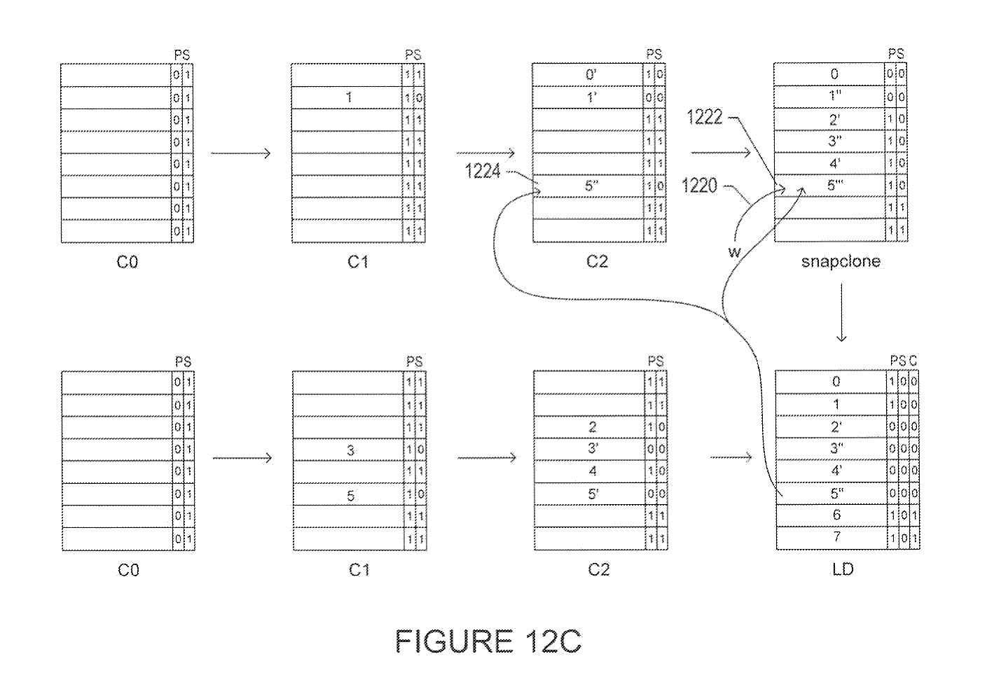

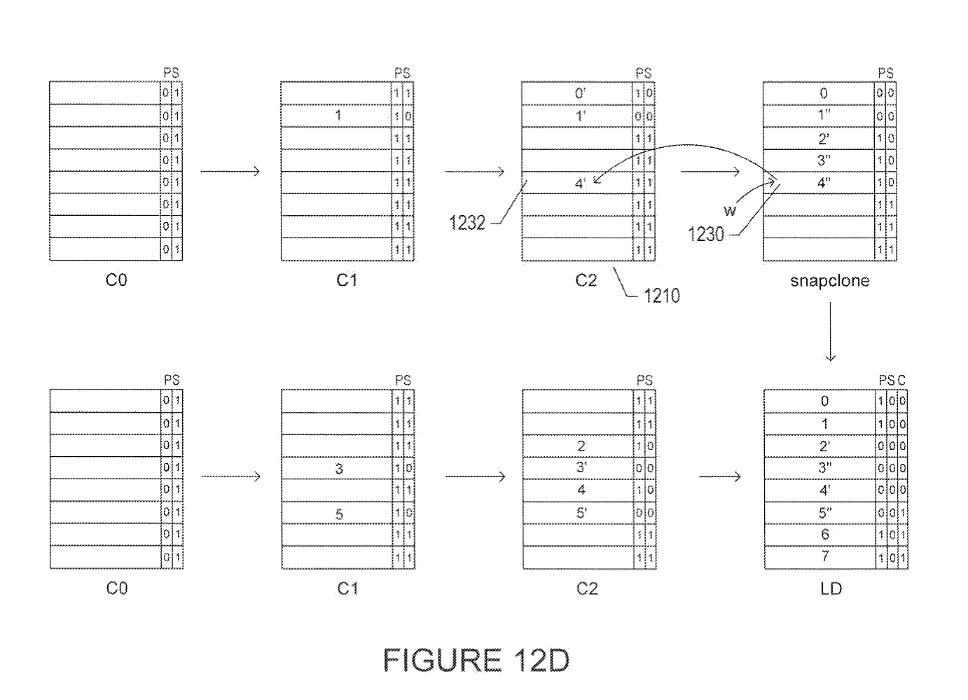

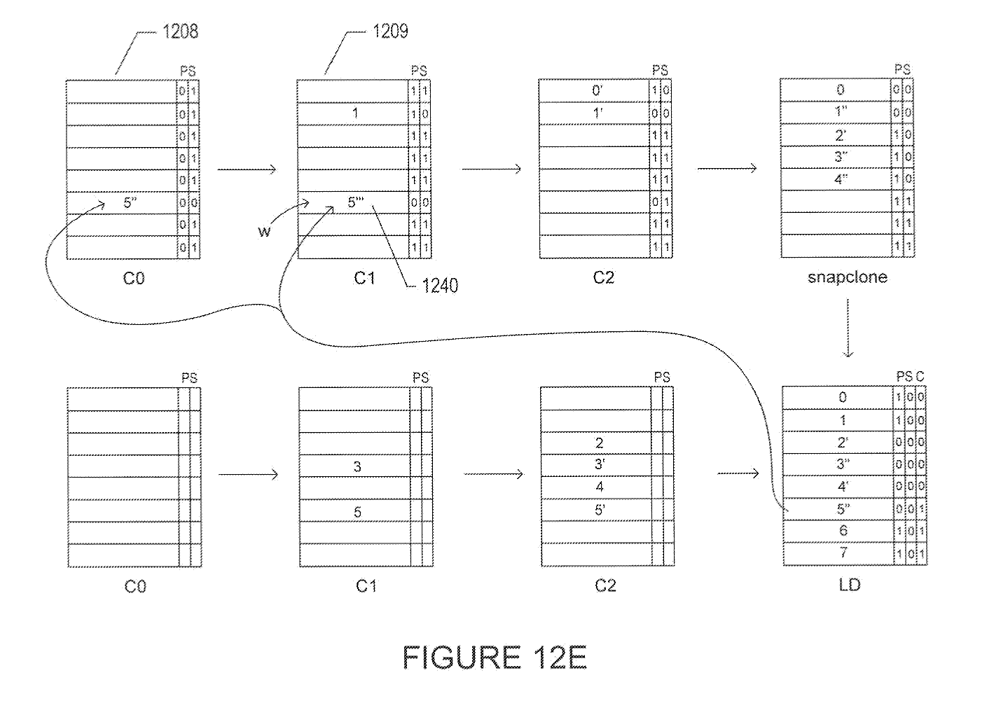

FIGS. 12A-12E illustrate various operations conducted on a snapclone that represents one embodiment of the present invention. FIGS. 12A-E use the same illustration conventions as used in FIGS. 9A-N. FIG. 12A shows a base logical device 1202 associated with a first stack of snapshot logical devices 1204-1206, a second stack of snapshot logical devices, and a snapclone logical device 1208-1211 associated with a base logical device 1202. FIG. 12A shows a logical device with two associated stacks similar to the logical device and two stacks shown in FIG. 10B. As discussed above, the base logical device 1202 has, in addition to p and s bits, a c bit, shown in column 1212, associated with each data segment. The p bit associated with each data segment in the base logical device is basically a backward link to the first stack of snapshot logical devices 1204-1206 and the c bit associated with each data segment in the base logical device is basically a backward link to the snapclone 1211 and associated snapshots 1208-1210. In FIG. 12A the background copy operation is underway, and the first five data segments of the base logical device have been copied to the snapclone.

In FIG. 12B, a WRITE operation is directed to the last data segment 1214 of the base logical device 1202. In order to carry out the WRITE operation, copy-before-WRITE operations are directed to the last data segments of the snapclone 1216 and the third snapshot logical disk 1218. Once the copy-before-WRITE operations are complete, the final data segment of the base logical device is updated by the WRITE operation. Note that, because of the new snapclone operation, a copy-before-WRITE operation need not be directed to the snapshot logical device 1210 that precedes the snapclone 1211 since the snapshot logical devices associated with the snapclone will remain associated with the snapclone following completion of the background copy operation.

FIG. 12C shows a WRITE operation directed to the sixth data segment of the snapclone in the snapclone, base logical disk, and associated snapshot-logical-disk stacks shown in FIG. 12A. The sixth data segment of the snapclone has not yet been copied from the base logical disk to the snapclone logical disk by the background-copy operation. In order to carry out the WRITE operation 1220, a copy-before-WRITE operation is carried out to the sixth data segment of the snapclone 1222 as well as to the sixth data segment of the snapshot preceding the snapclone 1224. Following completion of these two copy-before-WRITE operations, the WRITE 1220 can be executed to produce an altered sixth data segment within the snapclone, now designated “5′″.” Had there been no snapshot associated with the snapclone, the second copy-before-WRITE operation would have not been initiated. FIG. 12D shows a WRITE operation directed to the fifth data segment of the snapclone in the snapclone, base logical device, and associated stacks shown in FIG. 12A. In this case, because the fifth data segment 1230 of the snapclone has already been copied from the base logical device by the background-copy operation, a single copy-before-WRITE operation is directed to the fifth data segment 1232 of the snapshot preceding the snapclone 1210 before the WRITE operation can be executed. Finally, FIG. 12E illustrates a WRITE operation directed to a snapshot within the snapshot stack associated with a snapclone, according to one embodiment of the present invention. In this case, a WRITE operation is directed to the sixth data segment 1240 of the second snapshot 1209 in the snapshot stack associated with the snapclone because the second snapshot contains a reference to the sixth data segment which, by following the linked list of sixth data segments along the stack through the snapclone to the base logical device, refers to the sixth data segment of the base logical device. Therefore, prior to carrying out the WRITE operation, a copy-before-WRITE operation needs to be directed from the sixth data segment of the logical device to both the second snapshot logical device 1209 associated with a snapclone as well as the preceding, first snapshot logical device 1208 associated with the snapclone. Once the two copy-before-WRITE operations are carried out, the WRITE can be carried out on the sixth data segment of the second snapshot logical device 1209 associated with the snapclone, which is shown to have the new value “5′″.”

Although the present invention has been described in terms of particular embodiments, it is not intended that the invention be limited to these embodiments. Modifications will be apparent to those skilled in the art. For example, the new snapclone operation that represents one embodiment of the present invention can be implemented in many different ways by varying any of many different implementation parameters, including data structures, control structures, modular organization, and other such implementation parameters. The addition of c bits to the data segments of a base logical device, as discussed above, allows for a separate snapclone and associated snapshot stack to the logical device in addition to a stack of snapshot logical devices. This same technique can be employed to provide links to multiple stacks to additional types of logical devices. For example, addition of c bits to the metadata of snapclone logical devices would allow a snapclone operation to be directed to a snapclone. Alternatively, addition of c bits to the metadata of snapshot logical devices could allow for snapclone operations to be directed to snapshot logical devices.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A logical disk provided by a storage system, the logical disk comprising:
a number of data segments mapped to physical data-storage;
metadata, stored in an electronic memory and/or mass-storage devices, that includes, for each segment of the logical disk, a three-bit field; and
a set of operations, carried out by a storage-system controller, that can be directed to the logical disk by an entity that accesses the storage system, including a snapclone operation that generates a snapclone of the logical disk and a snapshot operation that generates a snapshot of the logical disk, when directed to the logical disk, and a snapshot of a snapclone of the logical disk, when directed to the snapclone of the logical disk.

2. The logical disk of claim I wherein the three-bit metadata field associated with each segment of the logical disk includes three S bits:
an s bit that indicates a forward link to a corresponding segment of a snapshot;
a p bit that indicates a backward link to a corresponding segment of a snapshot; and
a c bit that indicates a backward link to a corresponding segment of a snapclone.

3. The logical disk of claim 2 wherein a snapshot operation directed to the logical disk creates a snapshot that becomes, or is linked to, a linked stack of snapshots, the segments of which are linked together, by s and p metadata bits associated with each segment of each snapshot and the s and p bits associated with each segment of the logical disk, into linked lists, each linked list having one or more segment entries.

4. The logical disk of claim 2 wherein a snapclone operation directed to the logical disk creates a snapclone, the segments of which linked to the logical disk by s and p metadata bits associated with each segment of the snapclone and the s and c bits associated with each segment of the logical disk.

5. The logical disk of claim 2 wherein a snapshot operation directed to a snapclone of the logical disk creates a snapshot that becomes, or is linked to, a linked stack of snapshots linked to the snapclone, the segments of which are linked together, by s and p metadata bits associated with each segment of each snapshot and the s and p bits associated with each segment of the logical disk, into linked lists, each linked list having one or more segment entries.

6. The logical disk of claim 2 further including a snapclone operation directed to a snapclone logical disk and a snapclone operation directed to a snapshot logical disk.

7. A storage system comprising:
one or more electronic memories;
a number of mass-storage devices; and
one or more controllers which manage the memories and mass-storage devices to provide a logical-disk interface to accessing entities, the logical-disk interface including one or more logical disks, each of which comprises
a number of data segments mapped to the mass-storage devices and/or electronic memories,
metadata, stored in the electronic memories and/or mass-storage devices, that includes, for each segment of the logical disk, a three-bit field, and
a set of operations that can be directed to the logical disk by an entity that accesses the storage system, the operations carried out by the one or more controllers, the operations including a snapclone operation that generates a snapclone of the logical disk and a snapshot operation that generates a snapshot of the logical disk, an existing snapshot of the logical disk, or a snapclone of the logical disk.

8. The storage system of claim 7 wherein the three-bit metadata field associated with each segment of the logical disk includes three S bits:
an s bit that indicates a forward link to a corresponding segment of a snapshot;
a p bit that indicates a backward link to a corresponding segment of a snapshot; and
a c bit that indicates a backward link to a corresponding segment of a snapclone.

9. The storage system of claim 8 wherein a snapshot operation directed to the logical disk creates a snapshot that becomes, or is linked to, a linked stack of snapshots, the segments of which are linked together, by s and p metadata bits associated with each segment of each snapshot and the s and p bits associated with each segment of the logical disk, into linked lists, each linked list having one or more segment entries.

10. The storage system of claim 8 wherein a snapclone operation directed to the logical disk creates a snapclone, the segments of which linked to the logical disk by s and p metadata bits associated with each segment of the snapclone and the s and c bits associated with each segment of the logical disk.

11. The storage system of claim 8 wherein a snapshot operation directed to a snapclone of the logical disk creates a snapshot that becomes, or is linked to, a linked stack of snapshots linked to the snapclone, the segments of which are linked together, by s and p metadata bits associated with each segment of each snapshot and the s and p bits associated with each segment of the logical disk, into linked lists, each linked list having one or more segment entries.

12. The storage system of claim 8 wherein the one or more controllers, upon receiving a request to carry out a snapclone operation with respect to a base logical device on behalf of an accessing entity, executes the snapclone operation by:
creating a snapclone logical device;
for each segment in the base logical device,
setting the c bit of the S bits associated with the segment to indicate a backward link to a corresponding segment of the snapclone logical device; and
initiating a background copy of segments from the base logical device to the snapclone logical device.

13. The storage system of claim 12 wherein the background copy copies segments from the base logical device to the snapclone logical device by:
for each segment in the base logical device,
when the c bit of the S bits associated with the segment indicate a backward link to a corresponding segment of the snapclone logical device and when an s bit associated with the corresponding segment of the snapclone logical device indicates a forward link to the segment, copying the segment from the base logical device to the corresponding segment of the snapclone logical device.

14. The storage system of claim 8 wherein the one or more controllers, upon receiving a request to carry out a snapshot operation with respect to a snapclone logical device on behalf of an accessing entity, executes the snapshot operation by:
creating a new snapshot logical device;
when a snapshot is already associated with the snapclone logical device, setting a local variable to indicate backward linking;
when a snapshot is not already associated with the snapclone logical device, setting a local variable to indicate no backward linking;
linking the new snapshot logical device to the snapclone logical device and, when a snapshot is already associated with the snapclone logical device, linking the already-associated snapshot to the new snapshot logical device;
for each segment in the snapclone logical device,
setting a p bit associated with the segment to indicate a backward link from the segment to a corresponding segment of the new snapshot logical device;
setting an s bit associated with the corresponding segment of the new snapshot logical device to indicate a forward link to the segment; and
setting a p bit associated with the corresponding segment of the new snapshot logical device according to the local variable.

15. The storage system of claim 7 further including a snapclone operation directed to a snapclone logical disk and a snapclone operation directed to a snapshot logical disk.

16. A method for carrying out, by a controller of a storage system, a snapclone operation directed to a target logical device, the method comprising:
associating, with each segment of the target logical device, a three-bit metadata field, stored in one or more electronic memories and/or mass-storage devices, the three-bit metadata field containing
an s bit that indicates a forward link to a corresponding segment of a snapshot,
a p bit that indicates a backward link to a corresponding segment of a snapshot, and
a c bit that indicates a backward link to a corresponding segment of a snapclone;
when linking a snapshot logical device to the target logical device, linking segments of the snapshot logical device to corresponding segments of the target logical device using the p bits associated with segments of the target logical device as backward links;
creating a snapclone logical device and linking the snapclone logical device to the target logical device; and
linking segments of the snapclone logical device to corresponding segments of the target logical device using the c bits associated with segments of the target logical device.

17. The method of claim 16 wherein the controller, upon receiving a request to carry out a snapclone operation with respect to a target logical device, executes the snapclone operation by:
creating a snapclone logical device;
for each segment in the target logical device,
setting the c bit associated with the segment to indicate a backward link to a corresponding segment of the snapclone logical device; and
initiating a background copy of segments from the base logical device to the snapclone logical device.

18. The method of claim 17 wherein the background copy copies segments from the target logical device to the snapclone logical device by:
for each segment in the target logical device,
when the c bit associated with the segment indicate a backward link to a corresponding segment of the snapclone logical device and when an s bit associated with the corresponding segment of the snapclone logical device indicates a forward link to the segment, copying the segment from the base logical device to the corresponding segment of the snapclone logical device.

19. The method of claim 16 wherein the controller subsequently carries out a snapshot operation with respect to the snapclone logical device by:
creating a new snapshot logical device;
when a snapshot is already associated with the snapclone logical device, setting a local variable to indicate backward linking;
when a snapshot is not already associated with the snapclone logical device, setting a local variable to indicate no backward linking;
linking the new snapshot logical device to the snapclone logical device and, when a snapshot is already associated with the snapclone logical device, linking the already-associated snapshot to the new snapshot logical device;
for each segment in the snapclone logical device,
setting a p bit associated with the segment to indicate a backward link from the segment to a corresponding segment of the new snapshot logical device;
setting an s bit associated with the corresponding segment of the new snapshot logical device to indicate a forward link to the segment; and
setting a p bit associated with the corresponding segment of the new snapshot logical device according to the local variable.

20. The method of claim 16 wherein the target logical device is one of:
a base logical device;
a snapshot logical device; and
a snapclone logical device.
